(19) United States
(12) Patent Application Publication
(10) Pub. No.: US 2013/0334179 A1
(43) Pub. Date: Dec. 19, 2013

(54) Method for Operating a Resistance Welding Device

(71) Applicant: Robert Bosch GmbH, Stuttgart (DE)

(72) Inventor: Reinhard Scholz, Erbach (DE)

(21) Appl. No.: 13/919,205

(22) Filed: Jun. 17, 2013

(30) Foreign Application Priority Data
Jun. 19, 2012 (DE) 10 2012 012 056.7
Feb. 26, 2013 (DE) 10 2013 003 183.4

(51) Int. Cl. B23K 11/25

(52) U.S. Cl. CPC B23K 11/25
USPC 219/109

(57) ABSTRACT

The service life of the power semiconductors of a resistance welding device largely determines the reliability of the installation in operation. The disclosure proposes a method for monitoring the remaining service life of power semiconductors that are exposed to current during the operation of a resistance welding device. The fact that, when there is a change of load of at least one power semiconductor, the change in a power semiconductor parameter is determined and the service life of the power semiconductor is determined while taking into consideration a setpoint selection that is representative of the remaining service life allows the reliability of the installation to be drastically improved.

This application claims priority under 35 U.S.C. § 119 to patent application no. DE 10 2013 003 183.4, filed on Feb. 26, 2013 in Germany, and to patent application no. DE 10 2012 012 056.7, filed on Jun. 19, 2012 in Germany, the disclosures of which are incorporated herein by reference in their entirety.

The disclosure relates to a method for monitoring the remaining service life of power semiconductors of a resistance welding device that are exposed to current during the operation of the resistance welding device.

### BACKGROUND

Numerous components of machines, electrical installations or motor vehicles that are exposed to great mechanical or thermal stress have a material aging or wearing behavior that advances more quickly with increasing temperature. Power semiconductors may be mentioned here as examples.

If such components are exposed to thermal stress in a particular way beyond normal operation, unexpected adverse operational effects or even operational failures may occur. This can be countered either by the components being serviced at sufficiently frequent safety intervals or, where that is not possible, by them being exchanged in good time. However, servicing generally involves laborious intervention in the component concerned, it often only then being found that the component is still unrestrictedly operational, and consequently not yet in need of servicing. In the case of a routine exchange of components for safety reasons, such as for example electrical components where the extent to which they have aged cannot be established without destroying the component, there are often instances where components that are still quite able to operate for a considerable time are discarded.

There is therefore the need for a possible way of monitoring the aging or wearing behavior of components or other temperature-dependently aging articles by simple means.

In the case of the present systems, only loading limits of the power semiconductors are monitored. Once these limits have been reached and the monitoring takes effect, it is usually already too late.

### SUMMARY

The aim of the disclosed method is to provide preventive servicing that predicts the likely service life while taking into consideration the wear that has taken place up to that time.

For this, the disclosure provides a method as described herein.

The method makes it possible for the remaining service life of the power semiconductor of a resistance welding device, depending on the wear of the power semiconductors, to be communicated to a user, so that the latter can take the required measures at an early stage.

The disadvantages known from the prior art are thereby overcome.

### DETAILED DESCRIPTION

The method according to the disclosure can be used for all power semiconductors, for example the welding diodes in the welding transformer or the power semiconductors in the welding inverter or welding rectifier.

After each welding point, the temperature increase of the power semiconductor is determined by means of the welding current occurring during the welding, a scale graduation, various constants that are characteristic of the power semiconductor and the thermal resistance, corresponding to the welding time. On the basis of the welding cycles and in dependence on the temperature increase of the power semiconductor, the proportion of each welding point that is relevant to the service life of the power semiconductor can be summated and, using the manufacturer's specifications, the remaining service life can be automatically determined by the welding control.

What is claimed is:

1. A method for monitoring the remaining service life of power semiconductors of a resistance welding device that are exposed to current during operation of the resistance welding device, the method comprising:
determining a change in a power semiconductor parameter of at least one power semiconductor when there is a change of load of the at least one power semiconductor; and
determining a service life of the at least one power semiconductor with reference to a setpoint selection that is representative of the remaining service life.

2. The method according to claim 1, further comprising:
performing a welding operation, during which the change of load occurs; and
determining the change in the power semiconductor parameter with reference to a duration of the welding operation.

3. Method according to claim 1, further comprising:
storing every determined change in the power semiconductor parameter with reference to an associated change of load, so that a number of changes of load in relation to the change in the power semiconductor parameter is retrieved as a pair of values.

4. The method according to claim 1, wherein the at least one power semiconductor is included in at least one of a welding inverter, a welding transformer, and a welding rectifier.

5. The method according to claim 1, further comprising:
determining the remaining service life by a welding control of the resistance welding device.

6. The method according to claim 5, further comprising:
retrieving the remaining service life with an operator control device of the resistance welding device.

7. The method according to claim 2, wherein the power semiconductor parameter is a temperature of the at least one power semiconductor.
